(19) United States
(12) Patent Application Publication
(10) Pub. No.: US 2008/0092450 A1
(43) Pub. Date: Apr. 24, 2008

(54) Low wear slide rails

(76) Inventors: Ralf Balduck, Zwijndrecht (BE); Neville Whittle, Irwin, PA (US); Roger Kaufold, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/506,153

(22) Filed: Aug. 17, 2006

(51) Int. Cl. E06B 3/42; E05D 15/06; B21C 23/00; B05D 1/04; B05D 1/08

(52) U.S. Cl. 49/404; 16/96 L; 72/253.1; 427/446

(57) ABSTRACT

The present invention provides a retractable door apparatus for trailer trucks including at least two tracks of extruded aluminum each having at least one guide surface with a wear resistant coating; and a door in slideable engagement to the guide surfaces of each track. The wear resistant coating may include a self fluxing alloy, oxide, carbide, Al bronze alloy, or cermet having a hardness greater than aluminum. The present invention also provides a method of forming the tracks for the sliding or rolling door apparatus including the steps of providing an aluminum extrusion having at least one guide surface with a geometry for accepting a roller bearing or rollers; and forming the wear resistant coating on the guide surfaces at a temperature that does not substantially reduce the mechanical properties of the aluminum extrusion.

### FIELD OF THE INVENTION

The present invention relates generally to aluminum extruded track having a wear resistant coating. In particular, the present invention relates to aluminum extrusion guide surfaces with a wear resistant coating for a retractable door.

### BACKGROUND OF THE INVENTION

Metal parts or components are often used in a manner that requires them to rub against an adjacent hard surface. In such an environment, the metallic part or component may wear rapidly to the point of galling, and small pieces of the metallic part or component may wear off resulting in damage to adjacent structures, reduction in the life of the part or component, and other detrimental effects.

In one example, wear to the tracks 10 in sliding or rolling roof/door assemblies 100 of trailers utilized in the trucking industry, as depicted in FIGS. 1(a)-1(c), result in jamming that inhibits the movement of the roof or door assembly. One form of wear to the tracks 10 includes the formation of dents resulting from the repeated vibration of the roof rollers against the track 10. The rollers are designed to provide rolling engagement of a door or roof assembly 100 with the track 10. Referring to FIG. 1(a), a prior retractable roof assembly 100 is depicted in the closed position. Referring to FIG. 1(b), depicting the roof assembly 100 in a partially opened position, the rollers are attached to each transverse support bar 13 so that the each transverse support bar 13 slide along the guide surfaces or the tracks 10. FIG. 1(c) depicts the retractable roof 100 in the open position.

The repeated hammering of the rollers against the track 10 during trailer vibration creates a dent that deforms the track 10 in which the rollers of the door move. The rollers jam or stick within these dents making the opening and closing operations of the rolling roof/door assemblies 100 a labor intensive task, which in some instances can result in physical injury to the operator. Another factor influencing sticking of the assemblies is that during the service life of the rolling roof/door assemblies 100 the bearings in the rollers may fail resulting in the rollers being unable to roll. This may happen after a relative short time and inhibits the door's ability to be opened and closed.

As such, a need has developed for a wear resistant, low friction coating that may be applied on a metallic surface, such as the tracks of the rolling roof/door assembly, in which the coating has a greater degree of hardness and lubricity than the metallic surface on which it is applied. A further need exists for a wear resistant coating which may be applied to such a metallic surface to protect the surface when it is engaging adjacent hard surfaces so as to prevent denting, pitting, galling or other wear and thus increase the life thereof.

### SUMMARY OF THE INVENTION

Generally speaking, one aspect of the present invention, is a sliding or rolling door apparatus having a wear resistant coating formed on at least one wear surface of the track. Broadly, the apparatus includes:

at least two tracks each including at least one guide surface having a wear resistant coating; and

a retractable door in slideable engagement to the at least one guide surface of each of the at least two tracks.

In one embodiment, the term “slideable engagement” denotes that the retractable door is disposed along the guide surfaces of the tracks through a rolling or sliding mechanism. In one embodiment, the slideable engagement between the tracks and the door of the retractable door apparatus is provided by rollers positioned between the door and the guide surfaces. In one embodiment, the wear resistant coating may include a self fluxing alloy, oxide, carbide, aluminum bronze alloy, cermet or a combination thereof. The tracks may be aluminum extrusions.

In another aspect of the invention, a method is provided for forming the above described tracks with wear resistant coatings. Broadly, the method includes the steps of:

providing an aluminum extrusion having at least one guide surface with a geometry for accepting a roller; and

forming a wear resistant coating on at least one guide surface having a hardness greater than the aluminum extrusion.

In a preferred embodiment, the wear resistant coating is deposited using high velocity oxygen fuel (HVOF) thermal spray, wherein the temperature of the deposition process does not substantially reduce mechanical properties of the aluminum extrusion. In one example, the temperature of the deposition process is selected to ensure that the temperature of the aluminum extrusion does not exceed 100° C. during coating.

### BRIEF DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIGS. 1(a)-1(c) depict a prior retractable sliding or rolling door for trailer trucks.

FIG. 2 (cross-sectional side view) depicts one embodiment of a track including at least one guide surface having a wear resistant coating.

FIG. 3 (side view) depicts one embodiment of a track having a wear resistant coating and further discloses rollers in engagement with the track.

FIG. 4 (side view) depicts another embodiment of a track having a wear resistant coating.

FIG. 5 depicts a plot of average coefficient of friction v. time for an aluminum guide surface coated with NiCrB and for an uncoated aluminum guide surface.

### DETAILED DESCRIPTION OF THE INVENTION

The present invention is now discussed in more detail referring to the drawings that accompany the present application. In the accompanying drawing, like and/or corresponding elements are referred to by like reference numbers.

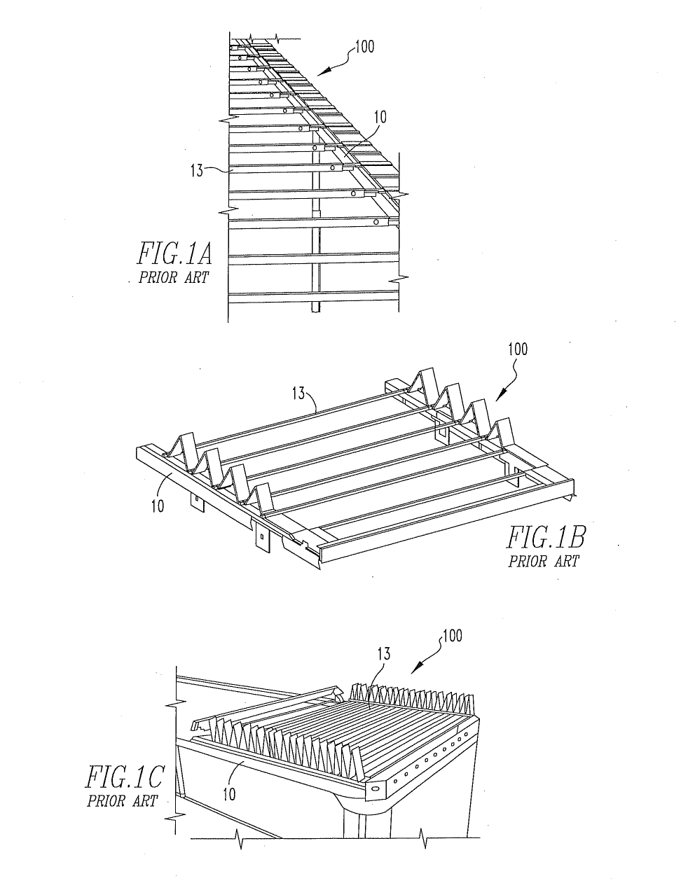

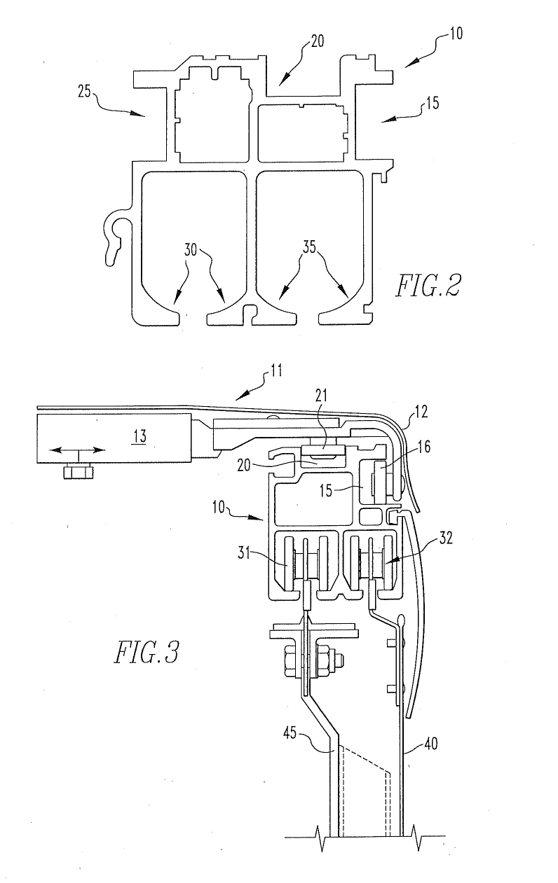

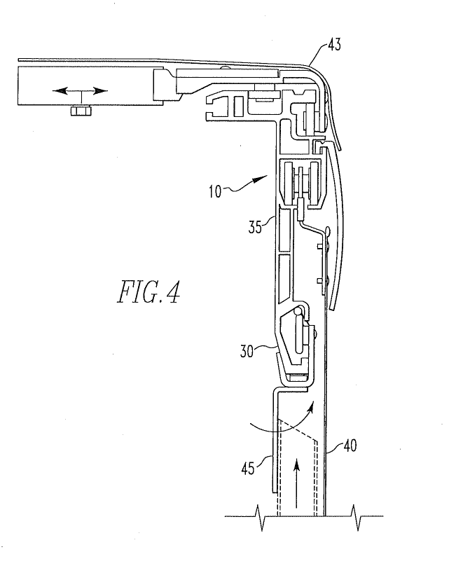

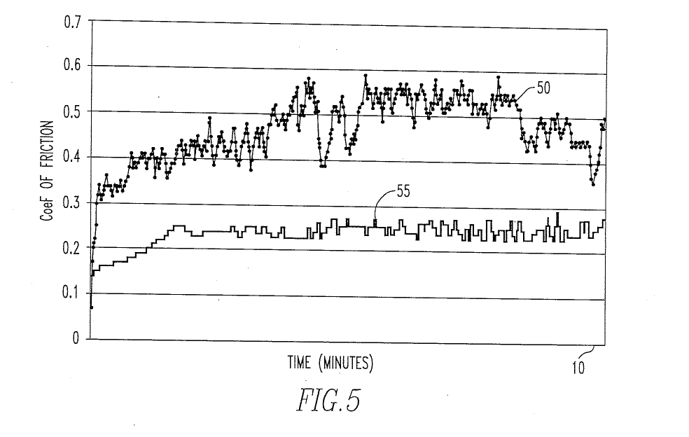

FIG. 2 depicts a track 10 that may be utilized in retractable sliding or rolling doors and roof assemblies for trailer trucks, in which the track 10 includes at least one guide surface 15, 20, 25 having a wear resistant coating. In a preferred embodiment, the track 10 is formed of aluminum or like alloy by an extrusion process. In operation, a track is positioned at each upper corner of a freight trailer and may provide guide surfaces for a sliding or rolling retractable roof, as depicted in FIGS. 1(a)-1(c), and retractable side panels (hereafter referred to as side curtains), as depicted in FIGS. 3 and 4.

Referring back to FIG. 2, in one embodiment, the track 10 provides three guide surfaces 15, 20, 25, for engagement to a retractable roof assembly, wherein each guide surface 15, 20, 25 engages at least one roller 16, 21, 31, 32. At least one of the guide surfaces 15, 20, 25 includes a wear resistant coating or protective overlay preferably positioned to improve the long term wear conditions of the truck's sliding or rolling tracks in the roof rails. In a preferred embodiment, the wear resistant coating to be applied has good resistance to in-service wear conditions and exhibits sufficient adhesion to the aluminum extruded track, thus enabling the wear resistant coating to perform it's intended purpose.

Most preferably, at least the exterior roof guide surface 15 facing outward from the trailer's longitudinal centerline includes the wear resistance coating. In another embodiment, the upper roof guide surface 20 is coating with a wear resistant coating, preferably in combination with a wear resistance coated exterior roof guide surface 15.

In another embodiment, the wear resistant coating is positioned on the interior roof guide surface 25, wherein the coating to the interior roof guide surface may be employed in combination with a wear resistant coating to the upper and exterior roof guide surfaces 20, 15, or without the wear resistant coating being applied to at least one of the upper and exterior roof guide surfaces 15, 20. In another embodiment, a wear resistant coating may also be applied to the guide surfaces 30, 35 for the side curtains.

The wear resistant coating may have a thickness ranging from about 0.001 inch to about 0.010 inch, preferably being about 0.002 inch to about 0.004 inch, and may include a self fluxing alloy, oxide, carbide, aluminum bronze alloy, cermet or a combination thereof. Examples of self fluxing alloys that are suitable for providing the wear resistant coating include NiCrB, NiCrBSi, CoNiCrBSi or combinations thereof. Examples of oxides that are suitable for providing the wear resistant surface include alumina (Al203), chromium oxide (Cr203), zirconium oxide (ZrO2), titanium oxide (TiO2) or combinations thereof. Examples of carbides that are suitable for providing the wear resistant surface include tungsten carbide (WC), tungsten-titanium carbide (WTiC), tungsten-chromium carbide (WCrC), chromium carbide (CrC), or combinations thereof.

Cermets that are suitable for providing the wear resistant surface include composites composed of ceramic and metallic materials. The ceramic material may include an oxide, boride, carbide, alumina or combination thereof. The metallic is used as a binder for an oxide, boride, carbide, or alumina. The above described oxides and carbides are suitable as ceramics for cermets within the present invention. Borides may include TiB2, Ti2B, ZrB, ZrB2 and ZrB12. In one embodiment, the metallic elements used are nickel, molybdenum, and cobalt. The cermets may also be metal matrix composites, but are typically less than 20% metal by volume. Preferred cermets include tungsten carbide with a cobalt binder and tungsten carbide with a nickel binder.

Aluminum bronze alloys may include greater than 90 percent copper and less than 10 percent aluminum. It is noted that the above examples are provided for illustrative purposes, and that the wear resistant coating is not deemed to be limited thereto, as the wear resistant coating may be any material having a hardness greater than aluminum and capable of being deposited without substantially decreasing the mechanical properties of extruded aluminum.

The wear resistant coating preferably has a hardness greater than aluminum. Aluminum alloys typically have hardnesses in the range 40 to 160 Brinell. The hardness of the wear resistant coatings can be custom tailored dependent upon material selection. For example, wear resistant coatings of aluminum bronze compositions, in accordance with the present invention, may have a hardness similar, preferably being greater than, the highest hardness levels produced by aluminum alloys and being on the order of about 160 Brinell (approximately 85 Rockwell B Scale) (approximately 170 Vickers Hardness). In some examples, carbide or cermet coatings in accordance with the present invention provide up to 3 to 4 times greater than the highest hardness values for aluminum. For example, in one preferred embodiment of the present invention, a wear resistant coating of NiCrB has a Vickers Hardness on the order of 725.

Referring to FIG. 3, one embodiment of a track 10 is depicted illustrating engagement of the rollers of the retractable roof 100 to the exterior guide surface 15 and upper guide surface 20 of an extruded aluminum track 10, wherein each guide surface comprises a wear resistant coating. It is noted that the rollers 16, 21 contact each wear resistant surface, wherein the wear-resistant coating is positioned along the surfaces on which the roof assembly rollers 16, 21 run. Each set of rollers 16, 21 are connected to a traverse support structure 13, wherein the traverse support structure 13 may be slideably moved along the length of the track 10 from a closed position to an open position, and vice versa. The roof assembly includes a plurality of traverse support structures 13 each being slideably engaged to the track 10 as illustrated in FIG. 3. The retractable roof further includes an outer surface 12 overlying the traverse support structures 13.

The track 10 may further provide side curtain guide surfaces 30, 35 for rolling engagement of the side curtains 40, 45. Still referring to FIG. 3, in one embodiment, the side curtain guide surfaces 30, 35 are adjacent to one another along a horizontal axis. Each side curtain 40, 45 is in rolling engagement to the track 10 through a side curtain rollers 31, 32. In one embodiment, the surface at which the side curtain roller 31, 32 contacts the guide surfaces 30, 35 of the track 10 may further include a wear resistant coating similar to the coating disposed on retractable roof assembly guide surfaces 15, 20, as described above. The track 10 may further comprise a notch 55 for attachment of a protective shield 56 overlying the portion of the track 10 that houses the guide surfaces 30, 35 for the side curtains 40, 45. FIG. 4 depicts another embodiment of the present invention, in which the track 10 contains side curtain guide surfaces 30, 35 that are adjacent to one another along a vertical axis. The structure depicted in FIG. 4 may comprise wear resistitive coatings along the portions of the track in which wear may be anticipated, similar to the coatings described above with reference to FIGS. 2 and 3.

In one embodiment of the present invention, in a further effort to facilitate opening and closing of the retractable sliding or rolling doors, the friction between the roller 16, 21, 31, 32 and at least one of the guide surfaces 15, 20, 25 is lowered by the wear resistant coating and/or by the addition of a solid lubricant coatings like teflon, Mo based (e.g. molybdenum disulphide), tin based, ceramic and/or metal based solid lubricants. In the event of the bearings of the rollers 16, 21, 31, 32 cease to function, the lower friction characteristics of the wear resistant coating or solid lubricant against the steel rollers allows the rollers to slide with less force than with the uncoated aluminum rails.

In one embodiment, as opposed to uncoated guide surface composed of extruded aluminum, such as Aluminum Association 6061, an extruded aluminum guide surface having a NiCrB containing wear resistant coating provides an approximately 40% decrease in the guide surface's coefficient of friction, as illustrated in the plot of the coefficient of friction v. time for coated aluminum and uncoated aluminum surfaces depicted in FIG. 5. Preferably, the coefficient of friction of the wear resistant coating is less than less than 0.3 as measured using a block on ring wear test as defined by ASTM standard G77-05e 1, titled “Standard Test Method for Ranking Resistance of Materials to Sliding Wear Using Block-on-Ring Wear Test”. The plot of coefficient of friction v. time depicted in FIG. 5 was generated by a Flaxen Block-On-Ring Test Machine in accordance with ASTM G77-05e 1, in which the ring was composed of steel and further included sensors for measuring the torque transmitted to the ring by a block sample under a 25.0 lb load for a 10.0 minute period. The torque was then converted to coefficient of friction.

A coated sample block was prepared by high velocity oxygen fuel (HVOF) thermal spray coating an extruded guide surface of Aluminum Association 6061 alloy with NiCrB to a thickness on the order of about 0.002 inch to about 0.004 inch, and then sectioning the extruded guide surface to sample size. A comparative non-coated sample block of Aluminum Association 6061 alloy was prepared in a similar manner as the coated sample block. Referring to FIG. 5, in comparison to a sample representative of an uncoated guide surface 50 having an average coefficient of friction being on the order of approximately 0.5, a sample coated with a NiCrB wear resistant coating 55, in accordance with the present invention, has an average coefficient of friction on the order of approximately 0.025, which represents a reduction in the coefficient of friction being greater than 40%.

Another aspect of the present invention is a method of forming the tracks 10 having wear resistive coatings, as described above. The mechanical properties of the aluminum component are not appreciably affected by the coating technology for depositing the wear resistant coating. Preferably, the coating process does not raise the temperature of the aluminum being coated to greater than 100° C. during deposition. Preferably, the coating deposition process includes thermal spray-technology, such as high velocity oxygen fuel (HVOF) thermal spray. The wear resistant coating may alternatively be deposited by detonation thermal spray, low velocity combustion thermal spray, plasma thermal spray, twin wire arc thermal spray, cold gas spray technology, kinetic spray, kinetic metallization, anodizing and electrostatic spray. Further, any deposition technology that may form the above described wear resistant coating locally to the extruded rail with adhesive and hardness properties suitable for improving the wear resistance of the track 1.0, without reducing the mechanical properties of the track, has been contemplated and is within the scope of the invention.

The present invention provides tracks 10 suitable for retractable roof assemblies and side curtains in truck trailers, in which a wear resistive coating applied to the track's guide surfaces 15, 20, 25, 30, 35 substantially reduces the wear to the guide surfaces of the tracks and the rollers of the doors and/or side curtains, hence increasing the service life of guide surfaces and decreasing maintenance.

The present invention further provides a retractable roof assembly having wear resistant tracks that substantially eliminate the incidence of jamming that is typically present in prior retractable roof assemblies having track assemblies that erode over the service life of the vehicle in which the retractable roof assembly is mounted.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. a door apparatus comprising:
at least two tracks each comprising at least one guide surface having a wear resistant coating; and
a door in slideable engagement to the at least one guide surface of each of the at least two tracks

2. The door apparatus of claim 1, wherein the slideable engagement is provided by at least one roller between the door and each of the at least one guide surface.

3. The door apparatus of claim 1 wherein the wear resistant coating comprises a self fluxing alloy, oxide, carbide, Al bronze alloy, cermet or combination thereof.

4. The door apparatus of claim 3 wherein the self fluxing alloy comprises NiCrB, NiCrBSi, CoNiCrBSi or combinations thereof.

5. The door apparatus of claim 3 wherein the oxide comprises alumina (Al₂O₃), chromium oxide (Cr₂O₃), zirconium oxide (ZrO₂), titanium oxide (TiO₂) or combinations thereof.

6. The door apparatus of claim 3 wherein the carbide comprises tungsten carbide (WC), tungsten-titanium carbide (WTiC), tungsten-chromium carbide (WCrC), chromium carbide (CrC), or combinations thereof.

7. The door apparatus of claim 3 wherein the cermet comprises a ceramic selected from the group consisting of oxides, borides, carbides, alumina and combinations thereof; and a metal binder selected from the group consisting of nickel, molybdenum, cobalt and combinations thereof.

8. The door apparatus of claim 3 wherein the aluminum bronze alloy comprises greater than 90 wt. % Cu and less than 10 wt %. Al.

9. The door apparatus of claim 1 wherein the wear resistant coating has a thickness ranging from about between 0.001-0.010 inch.

10. The door apparatus of claim 1 wherein the at least two tracks comprise of an aluminum extrusion.

11. The door apparatus of claim 1 wherein the wear resistant coating further comprises a solid lubricant coating.

12. The door apparatus of claim 11 wherein the solid lubricant coating comprises teflon, molybdenum based materials, or tin based materials.

13. The door apparatus of claim 1 wherein the wear resistant coating has a coefficient of friction less than 0.3.

14. A method of forming wear resistant aluminum extrusion comprising:
providing an aluminum extrusion having at least one guide surface with a geometry for accepting a rollers ; and
forming a wear resistant coating on the at least one guide surface having a hardness greater than the aluminum extrusion.

15. The method of claim 14 wherein the deposition does not substantially reduce mechanical properties of the aluminum extrusion.

16. The method of claim 15 wherein depositing the wear resistant coating comprises a deposition process having a process temperature less than 1200° F.

17. The method of claim 16 wherein the deposition process comprises high velocity combustion thermal spray.

18. The method of claim 16 wherein the deposition process comprises detonation thermal spray, low velocity combustion thermal spray, plasma thermal spray, twin wire arc thermal spray, cold gas spray technology, kinetic spray, kinetic metallization, anodizing or electrostatic spray.

19. The method of claim 14 wherein the wear resistant coating has a thickness ranging from about between 0.001-0.010 inch.

20. The method of claim 19 wherein the wear resistant coating comprises a self fluxing alloy, oxide, carbide, Al bronze alloy, cermet or combination thereof.

21. The method of claim 20 wherein the wear resistant coating comprises NiCrB.
